(19) United States
(12) Patent Application Publication
(10) Pub. No.: US 2006/0069515 A1
(43) Pub. Date: Mar. 30, 2006

(54) Method and system for protein folding trajectory analysis using patterned clusters

(75) Inventors: Laxmi Priya Parida, Mohegan Lake, NY (US); Ruhong Zhou, Stormville, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/952,933

(22) Filed: Sep. 30, 2004

(51) Int. Cl. G06F 19/00

(52) U.S. Cl. 702/19

(57) ABSTRACT

A method (and system) of analyzing protein folding trajectory includes a combinatorial pattern discovery process for analyzing multidimensional data from a simulation of the protein folding trajectory. The method of analyzing protein folding trajectory allows a user to understand the global state changes and folding mechanism of a protein during its folding process. The method may further include generating a collection of data points by simulation experiments, analyzing the collection of data points to extract patterned clusters, filtering the patterned clusters to remove insignificant patterned clusters to obtain a collection of filtered patterned clusters and analyzing the collection of filtered pattern clusters.

### BACKGROUND OF THE INVENTION

1. Field of the Invention

The present invention generally relates to computational biology and mechanisms behind protein folding, and more particularly to a combinatorial pattern discovery method (and system) to protein folding trajectory data from simulation experiments. The method involves computations of clusters of data wherein each cluster has a signature pattern describing the elements of the cluster.

2. Description of the Related Art

Understanding how a protein folds into a functional or structural configuration is one of the most important and challenging problems in computational biology. The interest is not just in obtaining the final fold configuration (generally referred to as “structure prediction”) but also understanding the folding mechanism and folding kinetics involved in the actual folding process. Many native proteins fold into unique globular structures on a very short time-scale. The so-called “fast folders” can fold into the functional structure from a random coil in microseconds to milliseconds.

Recent advances in experimental techniques that probe proteins at different stages during the folding process have shed light on the nature of the folding kinetics and thermodynamics. However, due to experimental limitations, detailed protein folding pathways remain unknown. Computer simulations performed at various levels of complexity, ranging from simple lattice models to all-atom models with explicit solvents, can be used to supplement experiments and fill in some of the gaps in knowledge about protein folding mechanisms.

Large scale simulations of protein folding with realistic all-atom models still remains a great challenge. Enormous effort is required to solve this problem. One example solution is the recent IBM Blue Gene project, which is aimed at building a supercomputer with hundreds of teraflop to petaflop computing power to tackle the protein folding problem. However, effective analyses of the trajectory data from the protein folding simulations, either by molecular dynamics or the well-known MonteCarlo method, remains a great challenge due to the large number of degrees of freedom and the huge amount of trajectory data.

Currently, the protein folding mechanism is often characterized by calculating the free energy landscape versus reaction coordinates. Various reaction coordinates are used, such as the fraction of native contacts, the radius of gyration of the entire protein, the root mean square derivative (RMSD) from the native structure, the number of β-strand Hydrogen bonds, the number of α-helix turns, the hydrophobic core radius of gyration, and the principal components (PC) from principal component analysis (PCA). Principal component analysis (PCA) is a method of analyzing multivariate data in order to express their variation in a minimum number of principal components or linear combination of the original, partially correlated variables. Searching for improved reaction coordinates is still of great interest in protein folding mechanism studies.

FIGS. 9 and 10 depict conventional free energy contour maps for analyzing protein folding trajectories. FIG. 9 is a free energy contour map illustrating the fraction of native contact ρ versus the radius of gyration of the entire peptide R_{g} at 310K.

FIG. 10 is a contour map illustrating the principal component PC-1 versus the principal component PC-2. This conventional method of plotting and analyzing contour maps is a manual method of analyzing protein folding trajectory data. As shown in FIGS. 9 and 10, the conventional contour map analysis is limited in that it is two dimensional (e.g., only two reaction coordinates may be plotted and analyzed at a time). A problem with this conventional, manual method is that many protein folding configurations may be overlooked.

These analyses have provided important information for an improved understanding of protein folding. However, contour map analysis often requires a priori knowledge about the system under study and the free energy contour maps usually result in a large degree of information reduction due to their limit in dimensionality (e.g., which is limited to two or three). Thus, improved or complementary analysis tools are in great demand.

Additionally, conventional analysis methods are further limited in that they are generally manual processes. That is, “manual” in the sense that the data is plotted on contour maps, which are then visually analyzed. This manual operation increases the amount of time required to analyze the protein folding trajectory data. Furthermore, the manual operation limits the amount of protein folding trajectory data that may be analyzed, which limits the accuracy of the conventional analysis methods.

### SUMMARY OF THE INVENTION

In view of the foregoing and other exemplary problems, drawbacks, and disadvantages of the conventional methods and structures, an exemplary feature of the present invention is to provide a method and structure in which global state changes of the configurations of a protein during a protein folding mechanism can be understood.

In a first aspect of the present invention, a method of analyzing protein folding trajectory includes a combinatorial pattern discovery process that analyzes multidimensional data from a simulation of the protein folding trajectory. The method includes generating a collection of data points by simulation experiments, analyzing the collection of data points to extract patterned clusters, filtering the patterned clusters to remove insignificant patterned clusters to obtain a collection of filtered patterned clusters and analyzing the collection of filtered pattern clusters.

In a second aspect of the present invention, a computer system for analyzing a protein folding trajectory includes means for simulating a protein folding trajectory, means for analyzing multidimensional data from a simulation of the protein folding trajectory, and means for communicating to a user results of the analyzing multidimensional data from a simulation of the protein folding trajectory.

In a third aspect of the present invention, a signal-bearing medium tangibly embodies a program of machine readable instructions executable by a digital processing apparatus to perform a method of analyzing protein folding trajectory. The method of analyzing protein folding trajectory includes a combinatorial pattern discovery process that analyzes multidimensional data from a simulation of the protein folding trajectory.

In a fourth aspect of the present invention, a method of deploying computing infrastructure includes integrating computer-readable code into a computing system, wherein the computer readable code in combination with the computing system is capable of performing a method of analyzing a protein folding trajectory. The method of analyzing a protein folding trajectory includes a combinatorial pattern discovery process that analyzes multidimensional data from a simulation of the protein folding trajectory.

As discussed above, conventional analysis methods characterize the protein folding mechanism by calculating the free energy landscape versus the reaction coordinates such as the fraction of native contacts, the radius of gyration, and the principal components. By only analyzing this limited number of variables, the conventional analysis methods often overlook significant patterns that occur during the protein folding mechanism. Furthermore, the conventional analysis methods provide manual analysis methods that can only examine three or less dimensions at once, resulting in a slower, inaccurate analysis method.

Unlike the conventional analysis methods, the present invention provides a combinatorial algorithm approach towards understanding the global state changes of the folding configurations. The approach is based on cluster computation, each cluster being defined by a pattern of a combination of various reaction coordinates. By introducing notions that eliminate redundant clusters, the present analysis method limits the number of eligible clusters. An efficient (e.g., linear in output size) algorithm is then used to detect these clusters. The analysis method of the present invention then extracts crucial information about protein folding intermediate states and mechanism.

The analysis method of the present invention recovers protein folding intermediate states previously obtained by visually analyzing free energy contour maps. The analysis method of the present invention also succeeds in extracting meaningful patterns and structures that had been overlooked in previous work, which provide a better understanding of the folding mechanism (such as the exemplary β-hairpin protein). These new patterns also interconnect various states in existing free energy contour maps versus different reaction coordinates. The approach of the present analysis method does not require the free energy values, yet it offers improved analysis as compared to the methods that use free energy landscapes, thus to validate the choice of reaction coordinates.

It is also known that the folding process of many proteins takes the amino acid coil through different states before stabilizing on the final folded state. Thus, a first step towards understanding the folding process is to identify these states. The protein trajectory analysis method of the present invention uses a combinatorial pattern discovery technique to analyze protein folding trajectory data from simulation experiments. The procedure involves computations of clusters of the data, where each cluster has a signature pattern describing the elements of the cluster. The simplicity of the pattern leads to easy interpretation of and thus better understanding of the underlying processes. By appropriate redundancy checks, the number of clusters is made manageably small.

There are many advantageous results of this method. Firstly, the method is validated by comparing its results with previously published results with a free energy landscape analysis. Secondly, the method succeeds in extracting meaningful new patterns and structures (from a folded state) that are overlooked by conventional analysis methods. These new structures provide a better understanding of the folding mechanism of the protein. These new patterns also interconnect various states in existing free energy contour maps versus different reaction coordinates. This automatic discovery provides a much greater understanding of the folding process. Thirdly, the method validates the choice of reaction coordinates because the analysis without using free energy values compares well with the analyses that use them.

That is, a goal of the method and apparatus for analyzing protein folding trajectories is to automatically analyze significant pattern clusters of protein folding trajectory data using a large number of reaction coordinates. Automatic analysis of significant pattern clusters using a large number of reaction coordinates will reduce the time associated with the analysis of protein folding trajectories while providing an improved understanding of the intermediate configurations of the protein folding mechanism by minimizing the number of significant patterns that are overlooked.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 is a schematic diagram illustrating a schema 10 of a folding process of a hypothetical small protein;

FIG. 2 is a schematic diagram illustrating a hypothetical protein in an unfolded state 12;

FIG. 3 is a schematic diagram illustrating a hypothetical protein in a hydrophobic core collapsed state 14;

FIG. 4 is a schematic diagram illustrating a hypothetical protein in a partially folded state 16;

FIG. 5 is a schematic diagram illustrating a hypothetical protein in a folded state 18;

FIG. 6 is a flow diagram illustrating a method 600 of analyzing protein folding trajectory according to the present invention;

FIG. 7 is a block diagram illustrating the environment and configuration of an information system 700 for using the method of the present invention;

FIG. 7A is a block diagram illustrating a system 740 for using the method of the present invention;

FIG. 8 illustrates a storage medium 800 for storing steps of the program for analyzing protein folding trajectory;

FIG. 9 is a free energy contour map of the fraction of native contact ρ and the radius of gyration of the entire peptide R_{g} at 310K;

FIG. 10 illustrates a free energy contour map of the components PC-1 and PC-2; and

FIG. 11 is a schematic diagram illustrating a β-hairpin protein in an intermediate stage of the folding process.

### DETAILED DESCRIPTION OF EXEMPLARY EMBODIMENTS OF THE INVENTION

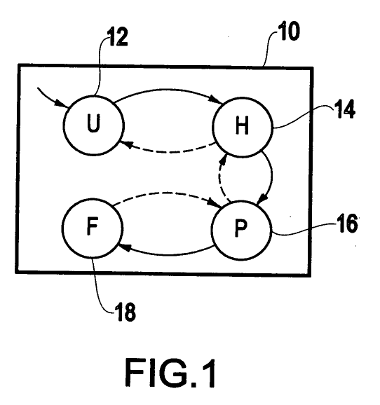

Referring now to the drawings, and more particularly to FIGS. 1-11, there are shown exemplary embodiments of the method and structures according to the present invention.

Well-known simulation methods exist to carry out the folding of a protein. However, it is often not sufficient to obtain a succinct understanding of the folding process. An exemplary and non-limiting aim of the present invention is to understand the folding mechanism by recognizing intermediate states that the folding process goes through. For example, the folding of a small protein (a chain of amino acids), a β-hairpin, could be understood at a global level in terms of the states shown in FIG. 1. It is a goal to understand the folding of every protein in this simplistic form. The conventional state-of-the-art analysis methods, however, are far from this goal.

FIG. 1 illustrates a schema of the folding process 10 for a small protein. The exemplary protein illustrated in FIGS. 1-5 is the β-hairpin protein. Obviously, the invention is not limited to this protein.

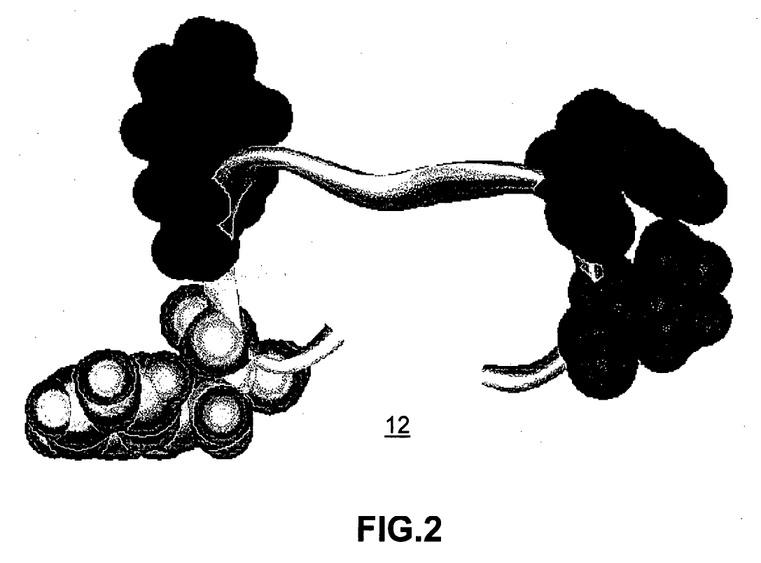

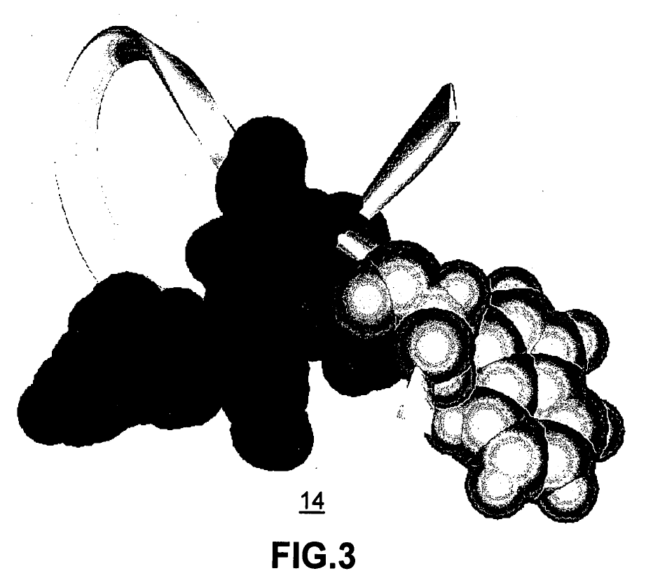

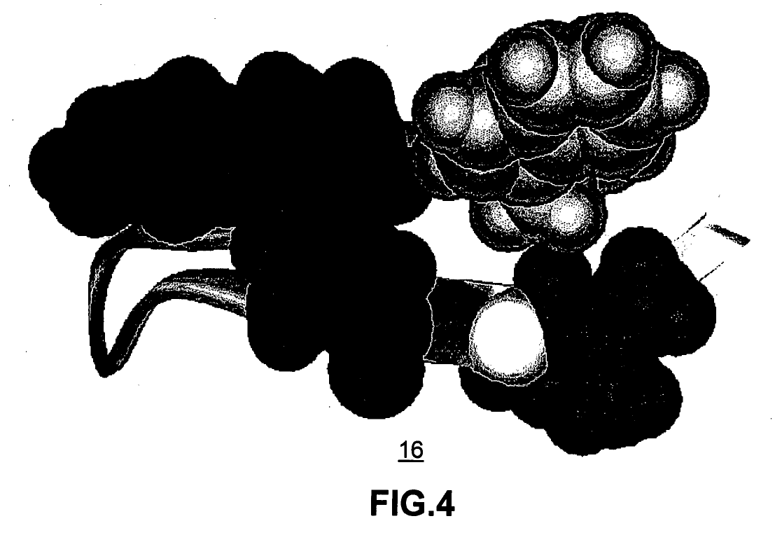

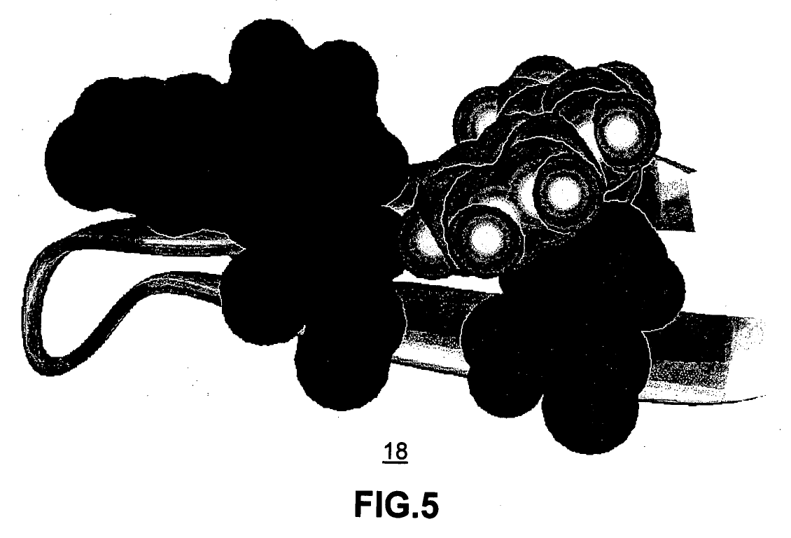

As shown in FIG. 1, the protein starts in an unfolded state (U) 12. FIG. 2 illustrates the β-hairpin protein in the unfolded state 12. The protein then changes to a hydrophobic core collapsed state (H) 14, as depicted in FIG. 3. The protein then moves to a partially folded (P) 16 state before finally ending at the folded state (F) 18. FIG. 4 depicts the β-hairpin protein in the partially folded state 16 and FIG. 5 depicts the β-hairpin protein in the folded state 18.

Each of the states depicted in the folding process 10 are not necessarily stable. Therefore, once a protein moves to a partially folded state (P) 16, it may revert back to the unfolded state (U) 12 before finally reaching the folded state (F) 18, as depicted in FIG. 1 by the dashed, reverse arrows.

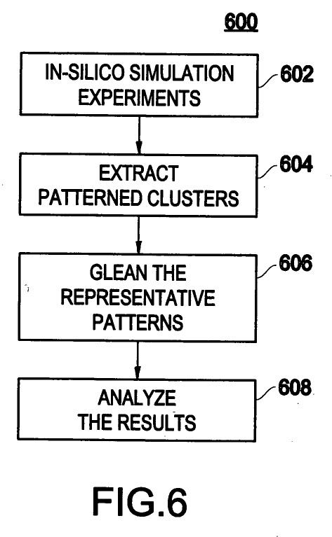

The present invention provides a four-step process towards understanding the folding of a protein. The four-step process of the protein folding trajectory analysis method 600 of the present invention is depicted in FIG. 6.

A first step involves the in-silico simulation 602 that gives rise to a large collection of data points, each point being an array of the characteristic features of the folding protein at a specific time point. For example, such characteristic features may include the radius of gyration or the number of hydrogen bonds, etc. According to certain exemplary embodiments of the present invention, the in-silico simulation 602 may include a Replica Exchange Molecular Dynamic (REMD) procedure.

The REMD procedure couples molecular dynamics trajectories with a temperature exchange Monte Carlo process for efficient sampling of the conformational space. In this method, replicas are run in parallel at a sequence of temperatures ranging from the desired temperature to a high temperature at which the replica can easily surmount the energy barriers. From time to time, the configurations of neighboring replicas are exchanged. Because the high temperature replica can traverse high energy barriers, a mechanism is provided for the low temperature replicas to overcome the quasi ergodicity they would otherwise encounter in a single temperature replica. This method is essentially a Monte Carlo method. Thus, the time series is not strictly real time due to the random Monte Carlo exchange process. However, any suitable simulation procedure may be used.

At each step of the in-silico simulation process 602, a configuration of the solvated protein can be computed. However, the in-silico simulation 602 may be carried out for nanoseconds to microseconds in units of femtoseconds (10⁻¹⁵). Thus, the number of such intermediate configurations may comprise approximately one million (1,000,000) data points. Thus, the analysis method 600 identifies and captures representative intermediate configurations. Since working in the structure space of the protein is extremely complex, the analysis method 100 identifies several key characteristic features of the protein, or reaction coordinates, and studies the trends and variations in these reaction coordinates.

In a second step 604, the data points are studied to extract patterned clusters based on the set of reaction coordinates. A combinatorial algorithm (e.g., clustering algorithms such as k-means algorithm, which is a well-known algorithm) is used to extract the patterned clusters from the data points. It is important to be able to extract patterned clusters because of the large number of data points (˜1,000,000) generated during the in-silico simulation 602. By extracting patterned clusters, the number of data points to analyze is reduced from approximately one million (1,000,000), to approximately one thousand (1,000).

Therefore, the combinatorial algorithm, such as the k-means algorithm, etc., is used in the patterned cluster extraction step 604 to reduce the size of the data field. Again, in the case of the β-hairpin, the data points are seven-dimensional, corresponding to the reaction coordinates of the protein at each time interval.

In a third step 606, these patterned clusters are filtered to retain the most significant clusters. The filtering step 606 gleans the representative patterns by reducing the data field from approximately one thousand (1,000) patterned clusters to approximately ten (10) patterned clusters that will be studied in detail. The patterned clusters are filtered in the third step 606 by modifying the parameters used to analyze the data field. The filtering step 606 limits the number of eligible patterned clusters by eliminating redundant clusters.

It is very difficult to model the significant patterns in this domain, so the second step 604 and third step 606 may be combined. Appropriate parameters are used to filter out possibly insignificant patterned clusters. For instance, if a pattern occurs less than k times, then the pattern is possibly not salient. Also control of the data field is exercised by the use of meaningful δ( ) functions, which will be discussed in detail below. The δ( ) may be a linear interval function such as [a,b] where b>a. However, more complicated functions can be used as well if the application so demands.

In step 608, the filtered patterned clusters are analyzed. The analysis step 608 involves extracting the structure of the protein folding configuration using the time coordinates and studying the correlation of the reaction coordinates of the different configurations. For instance, one could observe that the hydrophobic core is formed before the β-strand hydrogen bonds, or vice versa, and one can interconnect various free energy states in different free energy contour maps by monitoring the high dimensional (multi-column) patterns. These findings provide an improved understanding of the protein folding mechanism. Further, the time correlation between various patterned clusters or states is studied. For example, the analysis method 100 determines which pattern or state precedes the other and by how much time.

The data extraction is done using a combinatorial detection problem for at least three specific reasons.

First, the data is obtained from a Replica Exchange Molecular Dynamics (REMD) procedure where the time series is not strictly real time. Also, the analysis method finds patterned clusters that are not necessarily correlated in time.

Second, the combinatorial detection problem emphasizes that any probabilistic (or non-deterministic) component can be isolated from the algorithm and the problem. Any “fuzziness” in the data can be cleanly introduced using the δ( ) function values maintaining the problem definition unchanged and clean. Finally, the signature pattern of the cluster (hence the name patterned cluster) helps interpret the clusters quite easily. This feature enables the user to maintain tighter control on an acceptable pattern cluster that is also meaningful in terms of the folding process.

### EXEMPLARY EMBODIMENT

A small but important protein system, the 16-residue β-hairpin (GEWTYDDATKTFTVTE) from the C-terminus of protein G, is used to demonstrate the present approach to understanding the protein folding mechanism using the protein folding trajectory analysis method of the present invention.

An all-atom model is used for the description of the protein solvated in water. The Optimized Potential for Liquid Simulations—All-Atom (OPLS-AA) force field with an explicit solvent model, Simple Point Charge (SPC) model (both well-known), is used. A total of 64 replicas of the solvated system consisting of 4342 atoms are simulated with temperatures spanning from 270K to 695K. For each replica, a three nanosecond molecular dynamic simulation is run with replica exchanges attempted every 400 femtoseconds. For each conformation, seven different reaction coordinates are used (see Table 1 for details). There are a total of about 20,000 conformations saved for each replica. Table 1 lists a small portion of the data for the replica at 310K (37 Celsius), which is the biological temperature.

TABLE 1

| J₁ | J₂ | J₃ | J₄ | J₅ | J₆ | J₇ |
|---|---|---|---|---|---|---|
| N^{β}_{HB} | R^{core}_{g} | R_{g} | ρ | PC-1 | PC-2 | RMSD |
| 5.000 | 5.175 | 8.653 | 1.000 | −7.819 | −34.008 | 0.000 |
| 4.468 | 5.394 | 8.425 | 0.991 | −7.908 | −35.604 | 1.575 |
| 4.474 | 5.328 | 8.361 | 0.953 | −7.972 | −35.772 | 1.595 |
| 4.354 | 5.416 | 8.471 | 0.988 | −7.899 | −36.399 | 1.379 |
| 4.159 | 5.589 | 8.379 | 0.938 | −8.171 | −34.609 | 1.439 |
| 4.000 | 5.445 | 8.418 | 0.933 | −8.724 | −35.593 | 1.626 |
| 4.053 | 5.257 | 8.298 | 0.893 | −8.373 | −35.536 | 1.708 |
| 3.776 | 5.186 | 8.381 | 0.857 | −7.777 | −35.415 | 1.624 |
| 2.398 | 5.268 | 7.795 | 0.778 | −2.749 | −26.391 | 3.726 |
| 2.155 | 5.390 | 7.816 | 0.778 | −2.277 | −27.017 | 3.672 |
| 4.842 | 6.043 | 7.312 | 0.778 | 2.144 | −33.772 | 5.208 |
| 0.000 | 8.466 | 10.134 | 0.249 | −24.492 | 44.625 | 10.357 |
| 0.000 | 8.303 | 10.033 | 0.242 | −27.075 | 43.521 | 10.163 |
| 2.047 | 5.132 | 7.628 | 0.776 | −3.238 | −24.998 | 3.927 |
| 3.797 | 5.990 | 7.514 | 0.728 | −3.084 | −30.185 | 4.838 |
| 2.898 | 5.843 | 7.775 | 0.778 | −2.888 | −26.254 | 3.904 |

Table 1 provides raw data from the REM sampling of the β-hairpin folding in explicit water. Each column (i.e., J₁-J₇) corresponds to a different reaction coordinate/parameter. Each row of data points corresponds to data points taken at a specific time point. Table 1 depicts seven reaction coordinates. Specifically, column J₁ represents N^{β}_{HB}, the number of native β-strand hydrogen bonds. Column J₂ represents R^{core}_{g}, the radius of gyration of the hydrophobic core residues, tryptophan at position 43 (TRP43), tyrosine at position 45 (TYR45), phenylalanine at position 52 (PHE52), and valine at position 54 (VAL54). Column J₃ represents R_{g} the radius of gyration of the entire protein. Column J₄ represents ρ, the fraction of native contacts. Column J₅ represents PC-1, the first principal component from the Principal Component Analysis. Column J₆ represents PC-2, the second principal component. Column J₇ represents RMSD, the backbone root mean square deviation from the native structure. These seven reaction coordinates comprise the traditionally used parameters. However, any appropriate number or type of parameter may be used in place of these seven reaction coordinates. The parameters may be altered to determine the significant patterns extracted by the algorithm.

These simulations have revealed the hydrophobic-core driven folding mechanism that is obtained from the free energy contour map analysis. The analysis method 600 of the present invention applies a patterned cluster discovery algorithm to the above trajectory data to obtain new results and information that are not available using the conventional contour map analysis method. Since this is a well studied system and a large amount of data is available, comparisons with other analysis tools, such as the free energy contour map analysis, might be easier and more straightforward. Various reaction coordinates obtained from previous experiments serve as the starting point for the present analysis.

The δ( ) function of the cluster detection problem is defined as a constant. Thus δ(x)=c, for some constant c ε R for each x. The δ( ) may be changed. However, to extract different patterned clusters. The δ( ) functions for each column of Table 1 is given as follows: δ₁(x)=0.2, δ₂(x)=0.6, δ₃(x)=0.35, δ₄(x)=0.15, δ₅(x)=5.0, δ₆(x)=16.5, δ₇(x)=1.0 for all x. Further, the threshold parameter k is defined to be 2000.

Table 2 lists some representative patterns of size two with the above parameters. The term size in Table 2 refers to the number of reaction coordinates in the patterned cluster. The time sequences are not shown in Table 2 due to space constraints. These simple patterns can be directly compared with the previous free energy states displayed in the free energy contour maps. Free energy contour maps are 3-D plots of free energy versus a pair of reaction coordinates or data columns of Table 2.

TABLE 2

| | | |
|---|---|---|
| ID | Size | Cluster Pattern |

| | | | |
|---|---|---|---|
| 1 | 2 | J₁ = 4.886 +/− 0.2 | J₂ = 5.448 +/− 0.6 |
| 2 | 2 | J₁ = 2.875 +/− 0.2 | J₂ = 5.448 +/− 0.6 |
| 3 | 2 | J₂ = 4.979 +/− 0.6 | J₄ = 0.816 +/− 0.15 |
| 4 | 2 | J₂ = 5.871 +/− 0.6 | J₄ = 0.686 +/− 0.15 |
| 5 | 2 | J₂ = 4.979 +/− 0.6 | J₃ = 8.144 +/− 0.35 |

One might often want to study detailed patterns or structures in some predefined subregions such as the structures in the unfolded configuration. Evidence has shown that the protein structures in unfolded states are not fully extended, but often have well-defined structures instead. This can also avoid the problem that important patterns in these less populated areas are being overlooked due to a smaller population than the predefined quorum k. Thus, some less populated free energy states in free energy landscapes can be recovered by reducing the quorum.

Hence, another set of parameters has been used and here the search is confined to data points with N^{β}_{HB}=0.0 and R^{core}_{g}>5.0 Å, (see Table 1 for definitions of these reaction coordinates) where k=100. Yet another set of parameters included N^{β}_{HB}=0.0 and R^{core}_{g}>9.0 Å with k=50. A subset of the results are shown in Table 3.

TABLE 3

| ID | Size | Cluster Pattern | | |
|---|---|---|---|---|
| 1 | 1 | J₂ = 5.448 ± 0.5 | | |
| 2 | 2 | J₃ = 10.218 ± 0.2 | J₄ = 0.050 ± 0.15 | |
| 3 | 2 | J₃ = 10.773 ± 0.2 | J₅ = −21.188 ± | |
| | | | 15.0 | |
| 4 | 3 | J₃ = 10.208 ± 0.2 | J₄ = 0.050 ± 0.15 | J₇ = 9.299 ± 0.8 |
| 5 | 4 | J₂ = 9.632 ± 0.5 | J₃ = 10.302 ± 0.2 | J₅ = −21.188 ± 15.0 |
| | | J₇ = 9.299 ± 0.8 | | |
| 6 | 5 | J₂ = 9.951 ± 0.5 | J₄ = 0.050 ± 0.15 | J₅ = −21.188 ± 15.0 |
| | | J₅ = 36.517 ± 15.0 | J₇ = 9.872 ± 0.8 | |

Thus, this approach might be useful for hierarchical pattern searches which gradually zoom into the predefined subsets of data.

To obtain a representative structure from a set of configurations Cᵢ, the set is partitioned into a minimum number of groups Gⱼ such that for each Gⱼ there exists a representative Cⁱ_{j ε G}ⱼ and for each Cₖ ε Gⱼ, the structure corresponding to Cₖ is at most 1 Å RMSD from Cⁱⱼ. Thus, each Gⱼ will be esented by a structure corresponding to Cⁱⱼ.

The first type of data analysis in the analysis step 608 of the protein folding trajectory analysis method 600 includes recovering known free energy states. This type of analysis is done conventionally, as explained above, by using free energy contour maps. Thus, the previously found free energy or heavily populated states may be recovered using the method 600 of the present invention. The time sequence of each cluster pattern is then used to extract the corresponding conformations of the protein.

FIG. 5 shows a representative or most populated structure for the first pattern in Table 2. This structure mimics the representative structure from the folded state (F state) in the free energy contour map N^{β}_{HB} and R^{core}_{g} very well. Thus, this pattern resembles the folded state of the free energy contour map.

Similarly, the second pattern of Table 2 resembles the partially folded state, P state, in the same free energy landscape (see FIG. 4). Thus, the method 600 according to the present invention recovers the most populated states in the free energy landscape analysis.

The third and fourth patterns in Table 2 also resemble the folded state and the partially folded state, respectively, in the same free energy contour map versus N^{β}_{HB} and R^{core}_{g}. Numerous other patterns have shown similar results, i.e., recovering various previously found free energy states in the free energy contour maps versus different reaction coordinates. It should be noted though that many patterns might be redundant, either because the δ( ) function values given for reaction coordinates are too narrow, or some of the reaction coordinates are highly correlated. For example, the fifth pattern of Table 2 is R^{core}_{g}=4.979±0.6, R_{g}=8.144±0.35. Clearly, these two reaction coordinates are highly correlated, since R^{core}_{g} measures the radius of gyration of four key residues out of the total sixteen which is measured by R_{g}. However, for many other cases it may not be so obvious.

Thus, the method 600 of the present invention may recover known free energy states, as traditionally done with free energy contour map analysis. Contrary to the conventional free energy contour map analysis method, however, the method 600 of the present invention allows the user to recover known free energy states in a straightforward way.

In addition to recovering known free energy states, the analysis step 608 also interconnects various free energy contour maps, which cannot be done using conventional analysis methods.

More complicated patterns with many reaction coordinates are also found using the present method 600, which had been previously undetected by conventional contour map analysis.

In the traditional free energy contour map analysis, typically one or two reaction coordinates are used at each time, since a 2-D or 3-D free energy contour map is plotted. It is extremely difficult to visualize high dimensional free energy landscapes in order to identify the free energy basins or barriers. Table 4 lists some of these complicated patterns with up to six reaction coordinates.

TABLE 4

| ID | Size | Cluster Pattern | | |
|---|---|---|---|---|
| (1) | 3 | J₂ = 5.375 ± 0.6 | J₃ = 7.971 ± 0.35 | J₅ = −5.881 ± 5.0 |
| (2) | 3 | J₂ = 5.375 ± 0.6 | J₄ = 0.743 ± 0.15 | J₅ = −5.881 ± 5.0 |
| (3) | 3 | J₁ = 4.903 ± 0.2 | J₄ = 0.796 ± 0.15 | J₆ = −33.574 ± |
| | | | | 16.5 |
| (4) | 4 | J₁ = 4.903 ± 0.2 | J₂ = 5.375 ± 0.6 | J₄ = 0.870 ± 0.15 |
| | | J₆ = −33.574 ± 16.5 | | |
| (5) | 4 | J₁ = 4.903 ± 0.2 | J₂ = 5.375 ± 0.6 | J₅ = −5.881 ± 5.0 |
| | | J₆ = −33.574 ± 16.5 | | |
| (6) | 5 | J₃ = 8.144 ± 0.35 | J₄ = 0.815 ± 0.15 | J₅ = −5.881 ± 5.0 |
| | | J₆ = −33.574 ± 16.5 | J₇ = 3.292 ± 1.0 | |
| (7) | 5 | J₃ = 8.144 ± 0.35 | J₄ = 0.902 ± 0.15 | J₅ = −3.855 ± 5.0 |
| | | J₆ = −33.574 ± 16.5 | J₇ = 3.292 ± 1.0 | |
| (8) | 6 | J₁ = 4.950 ± 0.2 | J₃ = 8.013 ± 0.35 | J₄ = 0.848 ± 0.15 |
| | | J₅ = −5.881 ± 5.0 | J₆ = −33.574 ± 16.5 | J₇ = 3.292 ± 1.0 |
| (9) | 6 | J₂ = 5.748 ± 0.6 | J₃ = 8.013 ± 0.35 | J₄ = 0.848 ± 0.15 |
| | | J₅ = −5.881 ± 5.0 | J₆ = −33.574 ± 16.5 | J₇ = 3.800 ± 1.0 |

Of course, as pointed out earlier, some reaction coordinates might be correlated, so the data in each reaction coordinate may not be totally independent. Nevertheless, it still provides several advantages over the conventional analysis methods.

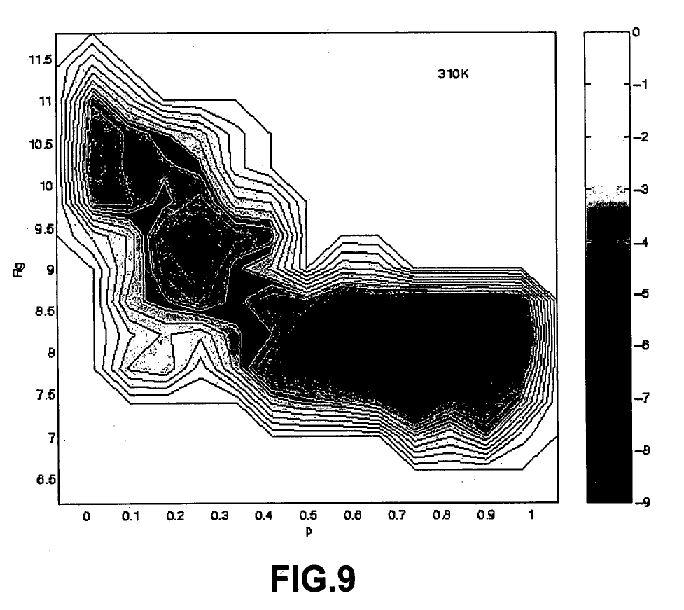

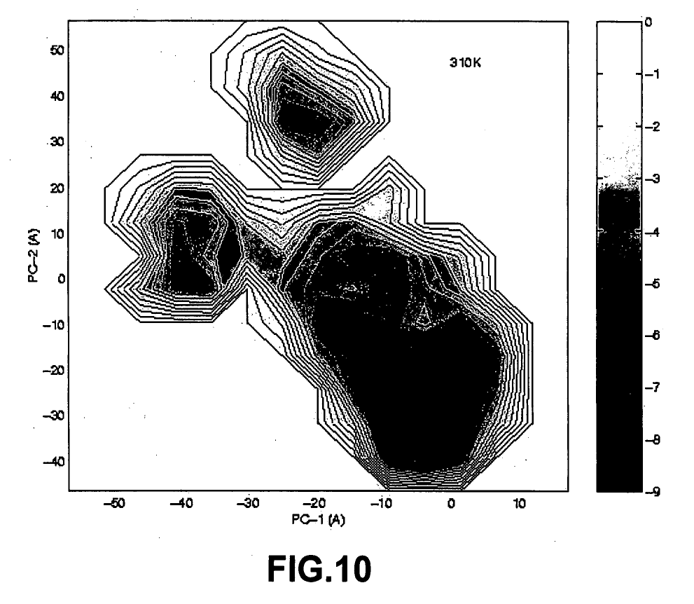

Firstly, these patterns can interconnect various free energy states in different free energy contour maps. This might not be so obvious in free energy contour maps themselves. For example, the sixth pattern in Table 4 interconnects the following two free energy contour maps: PC-1 and PC-2 (depicted in FIG. 10) and ρ and R_{g} (depicted in FIG. 9). The states corresponding to the free energy well (of value ˜−9KT) near PC-1=−5.9, PC-2=−33.6 in the first contour map and ρ=0.82, R_{g}=8.1 in the second contour map are indeed the same free energy state consisting of the same structures. In this particular case, they all represent the folded state (F state).

In addition to interconnecting various free energy contour maps, the method 600 of the present invention improves the understanding of the protein folding mechanism by revealing important structures previously overlooked by conventional methods. A “hydrogen bond zipping” mechanism is conventionally known in which folding initiates at the turn and propagates toward the tails by making β-strand hydrogen bonds one-by-one, so that the hydrophobic core, from which most of the stabilization derives, form relatively late during the folding. It is known that the β-hairpin protein undergoes a hydrophobic core collapse first, then makes native β-strand hydrogen bonds one-by-one.

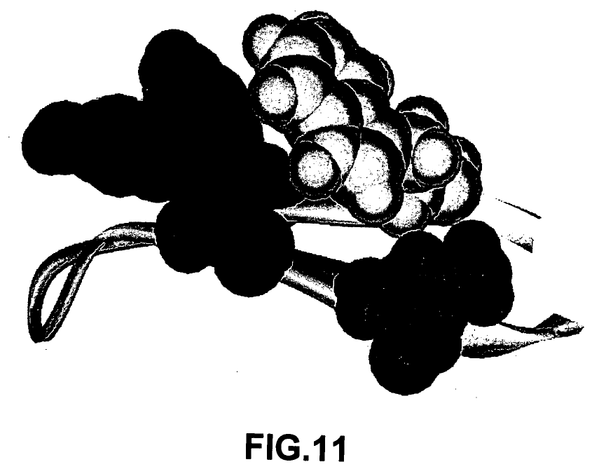

FIG. 11 shows a representative structure for the eighth pattern in Table 4. The structure shows that all of the five native β-strand H-bonds have been formed, but that the hydrophobic core is not completely aligned yet. This represents a new class of intermediate configurations previously overlooked in conventional free energy landscape analysis.

The loop region also bends towards the hydrophobic core to somewhat offset the non-perfect hydrophobic core. These structures with H-bonds formed, but where the hydrophobic core is not perfectly aligned (RMSDs up to 4 Å), implies that the β-hairpin can also have a path to form β-strand hydrogen bonds before the core is finalized. The current findings indicate that the final hydrophobic core and β-strand hydrogen bonds might be formed almost simultaneously. This can also be seen from the low free energy barrier in free energy landscapes.

Finally, the patterns of subsets of data in less populated states, such as the unfolded state, are studied in detail by focusing on these regions using a smaller quorum k and a different set of δ( ). As mentioned earlier, the protein structures in unfolded states are not fully extended, but often have well-defined structures instead.

The first pattern in Table 3 resembles the previous H-state in free energy contour map versus N^{β}_{HB} and R^{core}_{g} where the hydrophobic core is largely formed, but no native beta-strand H-bonds have been made yet. FIG. 3 shows a representative structure of this pattern, which mimics the structures from a previous H-state very well. FIG. 2 shows a representative structure for the sixth pattern in Table 3. This is the most populated structure of this β-hairpin in an unfolded state. Even though few structural features are found in this structure, it is certainly not fully extended either. Since this is a very small protein with only one secondary structure in the native state, not much has been identified in the unfolded state; for larger and more complicated protein systems, such as lysozyme, more structural features are expected in the unfolded state.

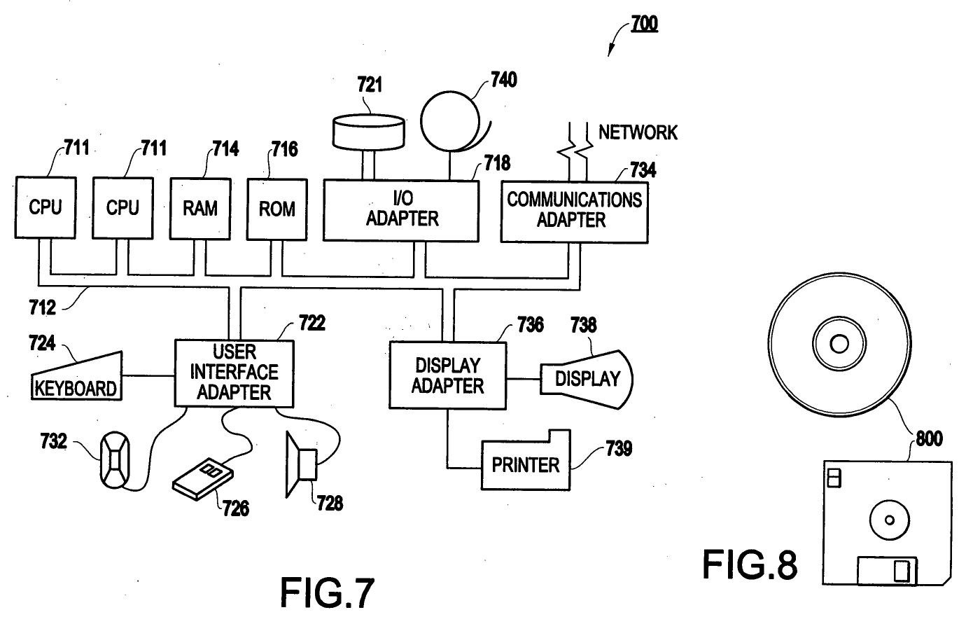

FIG. 7 shows a typical hardware configuration of an information handling/computer system in accordance with the invention that preferably has at least one processor or central processing unit (CPU) 711. The CPUs 711 are interconnected via a system bus 712 to a random access memory (RAM) 714, read-only memory (ROM) 716, input/output adapter (I/O) 718 (for connecting peripheral devices such as disk units 721 and tape drives 740 to the bus 712), user interface adapter 722 (for connecting a keyboard 724, mouse 726, speaker 728, microphone 732, and/or other user interface devices to the bus 712), communication adapter 734 (for connecting an information handling system to a data processing network, the Internet, an Intranet, a personal area network (PAN), etc.), and a display adapter 736 for connecting the bus 712 to a display device 738 and/or printer 739 (e.g., a digital printer or the like).

As shown in FIG. 7, in addition to the hardware and process environment described above, a different aspect of the invention includes a computer implemented method of performing a the inventive method. As an example, this method may be implemented in the particular hardware environment discussed above.

Such a method may be implemented, for example, by operating a computer, as embodied by a digital data processing apparatus to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 711 and hardware above, to perform the method of the present invention.

This signal-bearing media may include, for example, a RAM (not shown) contained with the CPU 711, as represented by the fast-access storage, for example. Alternatively, the instructions may be contained in another signal-bearing media, such as a magnetic data storage diskette or CD disk 800 (FIG. 8), directly or indirectly accessible by the CPU 711.

Whether contained in the diskette 800, the computer/CPU 711, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g., CD-ROM, WORM, DVD, digital optical tape, etc,), or other suitable signal-bearing media including transmission media such as digital and analog and communication links and wireless. In an illustrative embodiment of the invention, the machine-readable instructions may comprise software object code, compiled from a language such as “C”, etc.

FIG. 7A depicts a system 740 for analyzing a protein folding trajectory. The system 740 includes a protein folding trajectory simulator 750, an analyzer 760 for analyzing multidimensional data from a simulation of the protein folding trajectory, and a communicator 770 for communicating results of the analysis to the user of the system.

The protein folding trajectory analysis method according to the present invention provides an enhanced understanding of protein folding mechanisms. The method of the present invention provides a combinatorial pattern discovery algorithm that analyzes multi-dimensional data from the simulation of the protein folding trajectory. The present approach is based on cluster computation, each cluster being defined by a pattern of the reaction coordinates. A small but important protein system, a β-hairpin from the C-terminus of protein G, is used to demonstrate this approach. It is shown that the present inventive method not only reproduces the conventionally found free energy states (most populated states) in free energy contour maps, but also reveals new information overlooked previously in free energy landscape analysis concerning the intermediate configurations and folding mechanism.

The present method is also useful in making interconnections between various three dimensional free energy contour maps versus different reaction coordinates and also explains the mechanisms of the folding process. The present analysis method also validates the choice of reaction coordinates. While the above exemplary discussion concerns the β-hairpin protein, the method of the present invention may also be applied to any other larger protein molecules, such as the lysozyme protein (129 residues, 1976 atoms). Typically, a protein is considered to be a small protein if it has less than 100 residues.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of analyzing a protein folding trajectory, comprising:
conducting a combinatorial pattern discovery process,
wherein said combinatorial pattern discovery process comprises judging multidimensional data from a simulation of the protein folding trajectory.

2. The method according to claim 1, wherein said combinatorial pattern discovery process further comprises:
extracting an intermediate folding state, which occurs during the protein folding trajectory, from said multidimensional data.

3. The method according to claim 1, wherein said combinatorial pattern discovery process further comprises:
simulating the protein folding trajectory to generate a collection of data points;
studying said collection of data points to extract patterned clusters of data points based on a set of parameters;
filtering said patterned clusters to obtain a set of representative patterns; and
analyzing said set of representative patterns.

4. The method according to claim 3, wherein said analyzing comprises:
extracting at least one configuration of the protein during the protein folding trajectory using a time coordinate; and
studying a correlation of said parameters and each of said at least one configuration.

5. The method according to claim 3, wherein said simulating comprises an in-silico simulation process.

6. The method according to claim 3, wherein said patterned clusters are studied and extracted using a combinatorial pattern discovery algorithm.

7. The method according to claim 3, wherein said parameters comprise a set of reaction coordinates.

8. The method according to claim 7, wherein said patterned clusters are studied and extracted using at least two reaction coordinates.

9. The method according to claim 7, wherein said reaction coordinates are selected from the group consisting of a number of native beta-strand hydrogen bonds, a radius of gyration of hydrophobic core residues, a radius of gyration of the protein, a fraction of native contacts, a first principal component, a second principal component, and a backbone root mean square deviation from a native structure.

10. The method according to claim 3, further comprising:
validating the results of said analyzing using a free energy landscape analysis.

11. The method according to claim 3, wherein said analyzing comprises:
recognizing and extracting an intermediate configuration during the protein folding trajectory.

12. The method according to claim 3, wherein said filtering comprises modifying said set of parameters to eliminate a redundant patterned cluster.

13. The method according to claim 3, further comprising:
altering said set of parameters to extract a certain patterned cluster of data.

14. The method according to claim 3, wherein said analyzing comprises:
recovering known free energy states.

15. The method according to claim 14, wherein said known free energy states are recovered automatically.

16. The method according to claim 14, further comprising:
interconnecting various free energy contour maps.

17. A signal-bearing medium tangible embodying a program of machine readable instructions executable by a digital processing apparatus to perform a method of analyzing protein folding trajectory, said method comprising:
conducting a combinatorial pattern discovery process,
wherein said combinatorial pattern discovery process comprises judging multidimensional data from a simulation of the protein folding trajectory.

18. A method of deploying computing infrastructure, comprising integrating computer-readable code into a computing system, wherein the computer readable code in combination with the computing system is capable of performing a method of analyzing a protein folding trajectory, said method of analyzing a protein folding trajectory comprising:
conducting a combinatorial pattern discovery process,
wherein said combinatorial pattern discovery process comprises judging multidimensional data from a simulation of the protein folding trajectory.

19. A computer system for analyzing a protein folding trajectory, comprising:
means for simulating a protein folding trajectory;
means for analyzing multidimensional data from a simulation of the protein folding trajectory; and
means for communicating to a user results of the analyzing multidimensional data from a simulation of the protein folding trajectory.

20. A computer system for analyzing a protein folding trajectory, comprising:
a simulator that simulates a protein folding trajectory;
an analyzer for analyzing multidimensional data from a simulation of the protein folding trajectory; and
a communicator for communicating to a user results from the analyzer.

21. The computer system according to claim 20, wherein said computer system extracts an intermediate folding state, which occurs during the protein folding trajectory, from said multidimensional data.

22. The computer system according to claim 20, wherein said computer system simulates the protein folding trajectory to generate a collection of data points,
studies the collection of data points to extract patterned clusters of data points based on a set of parameters;
filters said patterned clusters to obtain a set of representative patterns; and
analyzes said set of representative patterns.

23. The computer system according to claim 22, wherein said analyzes comprises:
extracting at least one configuration of the protein during the protein folding trajectory using a time coordinate; and
studying a correlation of said parameters and each of said at least one configuration.

24. The method according to claim 20, wherein said simulator comprises an in-silico simulator.

25. The method according to claim 22, wherein said patterned clusters are studied and extracted using a combinatorial pattern discovery algorithm.

26. The method according to claim 22, wherein said parameters comprise a set of reaction coordinates.

27. The method according to claim 26, wherein said patterned clusters are studied and extracted using at least two reaction coordinates.

28. The method according to claim 26, wherein said reaction coordinates are selected from the group consisting of a number of native beta-strand hydrogen bonds, a radius of gyration of hydrophobic core residues, a radius of gyration of the protein, a fraction of native contacts, a first principal component, a second principal component, and a backbone root mean square deviation from a native structure.
